(19) United States
(12) Patent Application Publication
(10) Pub. No.: US 2008/0217414 A1
(43) Pub. Date: Sep. 11, 2008

(54) Flexible display member and article having the same

(75) Inventor: Katsuyuki Ito, Tokyo (JP)

Correspondence Address: KUBOTERA & ASSOCIATES, LLC, Suite 202, 200 Daingerfield Road, Alexandria, VA, 22314, US

(73) Assignee: Oki Data Corporation

(21) Appl. No.: 12/071,448

(22) Filed: Feb. 21, 2008

(30) Foreign Application Priority Data
Mar. 9, 2007 (JP) 2007-059338

(51) Int. Cl. G06K 19/06

(52) U.S. Cl. 235/492

(57) ABSTRACT

A flexible display member includes a base member having flexibility and a thin film LED (Light Emitting Diode) mounted on the base member. Accordingly, when the flexible display member is deformed, it is difficult to damage the flexible display member, thereby obtaining the flexible display member with high reliability.

### BACKGROUND OF THE INVENTION AND RELATED ART STATEMENT

The present invention relates to a flexible display member and an article having the flexible display member.

Conventionally, an RFID (Radio Frequency Identification) label, also called as an IC (Integrated Circuit) tag, is attached to an article for the purposes of management of products in a store, a warehouse, the likes; management of half-finished products in a factory and the likes; and management of various articles.

In a case of a non-contact type RFID label, an IC chip disposed in the RFID label is activated upon receiving power from a specific reader-writer device through an electro magnetic effect, so that information is read or written.

A technology has been developed, in which an LED (Light Emitting Diode) mounted on an RFID label is turned on when a specific reader device tries to obtain an access to information stored in an IC chip mounted on the RFID label (refer to Patent Reference). With the technology, an owner of an article with the RFID label attached thereon can recognize the attempt of obtaining an access to the information stored in the IC chip mounted on the RFID label.

### Patent Reference: Japanese Patent Publication No. 2003-123040

The conventional LED has a hard and fragile crystal structure, and is not flexible. On the other hand, it is necessary to make an RFID label flexible, so that the RFID label can be easily attached to an article. Accordingly, when the conventional LED without flexibility is mounted on the RFID label, the conventional LED may be damaged.

In the view of the problems described above, an object of the present invention is to provide a flexible display member and an article having the flexible display member capable of solving the problems of the conventional flexible display member. In the flexible display member, a thin film LED element is mounted on a base member with flexibility. Accordingly, when the flexible display member is deformed, it is difficult to damage the flexible display member, thereby obtaining the flexible display member with high reliability.

Further objects and advantages of the invention will be apparent from the following description of the invention.

### SUMMARY OF THE INVENTION

In order to attain the objects described above, according to the present invention, a flexible display member includes a base member having flexibility and a thin film LED (Light Emitting Diode) mounted on the base member.

In the flexible display member of the present invention, the thin film LED (Light Emitting Diode) is mounted on the base member having flexibility. Accordingly, when the flexible display member is deformed, it is difficult to damage the flexible display member, thereby obtaining the flexible display member with high reliability.

### BRIEF DESCRIPTION OF THE DRAWINGS

FIG. 1 is a schematic plan view showing a RFID (Radio Frequency Identification) label according to a first embodiment of the present invention;

FIG. 2 is a schematic sectional view showing the RFID label according to the first embodiment of the present invention;

FIG. 3 is a schematic sectional view showing a thin film LED (Light Emitting Diode) according to the first embodiment of the present invention;

FIGS. 4(a) to 4(f) are schematic views showing a process of producing the thin film LED according to the first embodiment of the present invention;

FIG. 5 is a schematic view showing a system of the RFID label and an RFID reader-writer device according to the first embodiment of the present invention; and

FIG. 6 is a schematic view showing a system of an RFID label and an RFID reader-writer device according to a second embodiment of the present invention.

### DETAILED DESCRIPTION OF THE PREFERRED EMBODIMENTS

Hereunder, embodiments of the present invention will be explained with reference to the accompanying drawings.

### First Embodiment

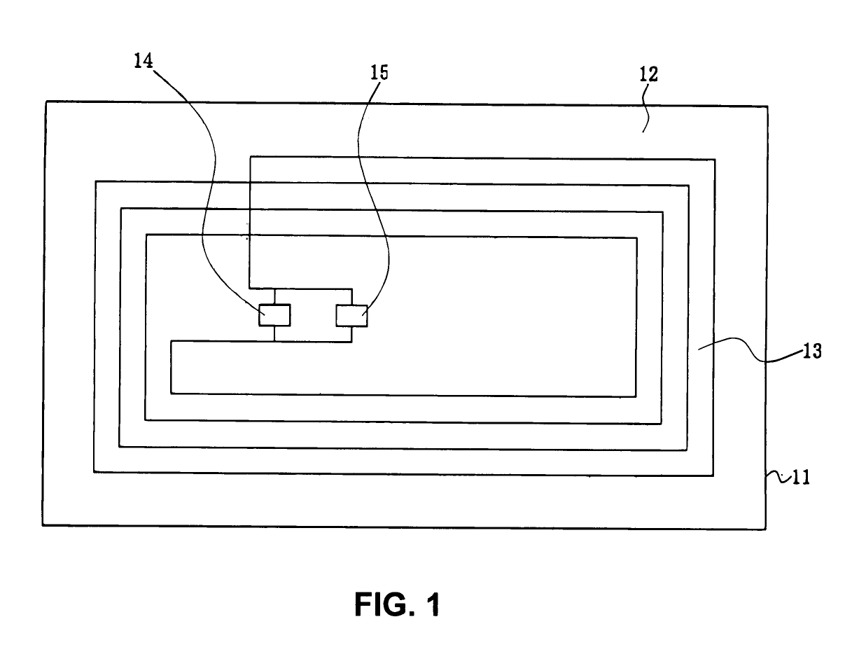

A first embodiment of the present invention will be explained. FIG. 1 is a schematic plan view showing a RFID (Radio Frequency Identification) label 11 as a flexible display member according to the first embodiment of the present invention.

The RFID label 11 is used for the purposes of, for example, management of products in a store, a warehouse, the likes; management of half-finished products in a factory and the likes; and management of various articles. The RFID label 11 stores various types of information such as identification information and management information of an article, so that the information can be read or written. In use, the RFID label 11 is attached to an article, a container retaining an article, a pallet with an article placed thereon, and may be used any purposes.

In the embodiment, the RFID label 11 is a non-contact type for reading and writing information without contacting with a reader-writer device, and may be a contact type for reading and writing information through contacting with a part of the reader-writer device.

As shown in FIG. 1, the RFID label 11 includes a base plate 12 as a base member having flexibility; an antenna 13 mounted on the base plate 12; an IC (Integrated Circuit) chip 14; and a thin film LED (Light Emitting Diode) 15 as a thin film LED element. The base plate 12 is formed of a thin plate member made of a plastic film such as PET (polyethylene-terephthalate), polyimide, and the likes; a coated paper; and the likes, and may be formed of any material.

In the embodiment, the antenna 13 is a thin wire having a coil shape of 3 to 10 turns and formed of a material such as copper, aluminum, and the likes. As far as being able to receive power from an RFID reader-writer device 21 (described later) through an electro magnetic effect, and to communicate with the base plate 12 through wireless communication, the antenna 13 may be formed of any material and have any shape.

In the embodiment, the IC chip 14 includes a semiconductor integrated circuit having a CPU (Central Processing Unit) as a calculation unit and a memory as a storage unit. As far as being able to store various types of information such as identification information and management information of an article so that the information can be read or written, the IC chip 14 may be any type.

In the embodiment, the thin film LED 15 is a laminated thin film formed through an epitaxial growth method using an inorganic material such as gallium arsenide, gallium nitride, gallium indium nitride, gallium aluminum nitride, aluminum nitride, and the likes. The thin film LED 15 emits red light (wavelength between 720 nm to 720 nm), and may emit green light (wavelength between 500 nm to 580 nm) or blue light (wavelength between 450 nm to 500 nm).

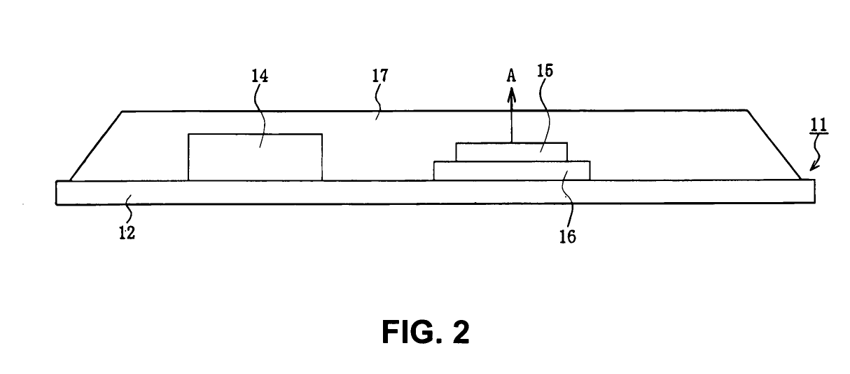

A configuration of the RFID label 11 will be explained next. FIG. 2 is a schematic sectional view showing the RFID label 11 according to the first embodiment of the present invention.

As shown in FIG. 2, a flattened film 16 is disposed on a surface of the base plate 12 in an area where at least the thin film LED 15 is mounted. The flattened film 16 is formed of an organic insulation film such as a polyimide film or an inorganic insulation film. Further, the flattened film 16 has a surface having a surface roughness less than few tens of nanometer. After the thin film LED 15 is peeled off from a base member 43 (described later), the thin film LED 15 is attached to and integrated with the flattened film 16.

In the embodiment, a protective film 17 is formed on the base plate 12 for covering the antenna 13, the IC chip 14, the thin film LED 15, and other wiring portions. The protective film 17 is formed of a silicone resin, an epoxy resin, and the likes, and protects the antenna 13, the IC chip 14, the thin film LED 15, and other wiring portions. With the configuration described above, the thin film LED 15 emits light passing through the protective film 17 in an arrow direction A.

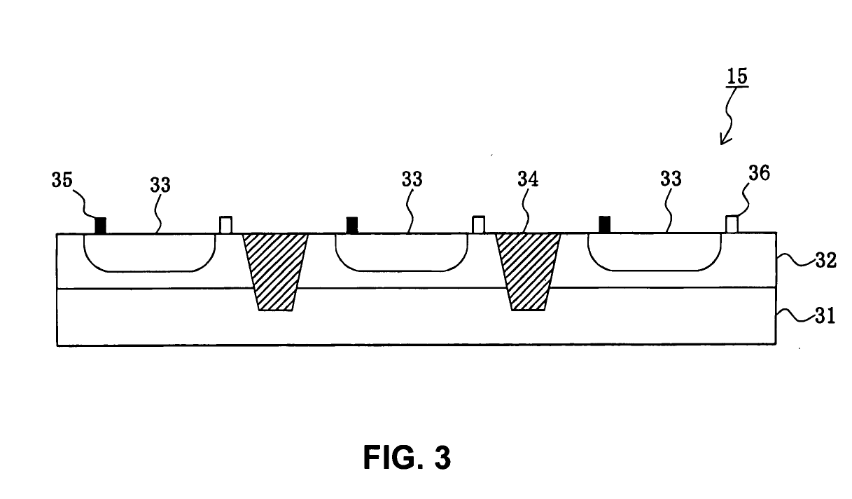

A structure of the thin film LED 15 will be explained in detail next. FIG. 3 is a schematic sectional view showing the thin film LED 15 according to the first embodiment of the present invention.

In the embodiment, the thin film LED 15 has the structure shown in FIG. 2 for emitting red light. More specifically, the thin film LED 15 includes a semiconductor layer 31 formed of semi-insulative or non-doped GaAs; an n-type semiconductor layer 32 formed of GaAs doped with an n-type impurity; and p-type semiconductor portions 33 formed through diffusing a p-type impurity (for example, Zn) from a side of a front surface of the n-type semiconductor layer 32. A p-n connection is formed in a boundary between the n-type semiconductor layer 32 and the p-type semiconductor portion 33 for functioning as an LED.

In the embodiment, the thin film LED 15 further includes element separation portions 34 for electrically separating the p-type semiconductor portions 33 arranged adjacent to each other. More specifically, the element separation portions 34 are formed of separation grooves reaching the semiconductor layer 31 and formed through etching and the likes. An insulation material may be filled in the separation grooves for flattening the separation grooves.

In the embodiment, p-side electrodes 35 are disposed at positions corresponding to the p-type semiconductor portions 33 and electrically connected to the p-type semiconductor portions 33, respectively. N-side electrodes 36 are disposed at positions corresponding to areas of the n-type semiconductor layer 32 electrically separated with the element separation portions 34, and electrically connected to the areas of the n-type semiconductor layer 32, respectively.

As described above, in the embodiment, the thin film LED 15 has the structure using GaAs as the semiconductor material for emitting red light. When the thin film LED 15 has a structure using AlGaInP or GaP as the semiconductor material, the thin film LED 15 emits green light. When the thin film LED 15 has a structure using GaN or InGaN as the semiconductor material, the thin film LED 15 emits blue light.

It is preferred that the semiconductor layers constituting the LEDs have a hetero structure or a double hetero structure. In the embodiment, the thin film LED 15 has an array of the LEDs, and may have a single LED depending on an application.

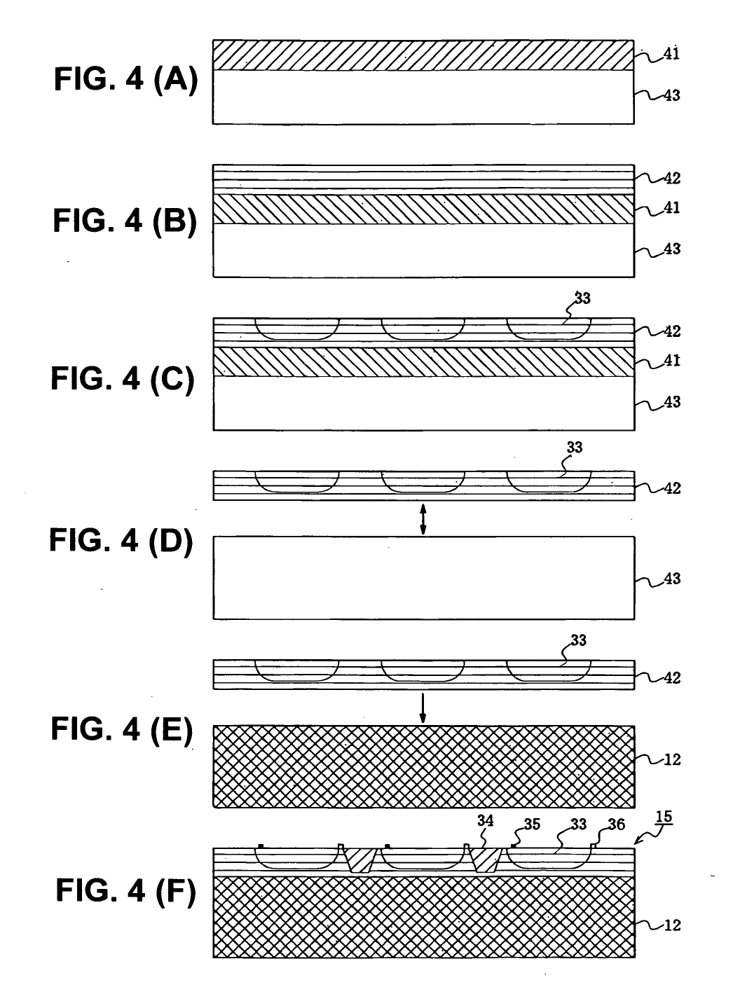

A process of producing the thin film LED 15 will be explained next. FIGS. 4(a) to 4(f) are schematic views showing the process of producing the thin layer LED 15 according to the first embodiment of the present invention. In the process, the thin film LED 15 has the structure for emitting red light.

First, as shown in FIG. 4(a), using a material such as AlAs, a sacrifice layer 41 is formed on the base member 43 formed of a material such as GaAs. Note that the base member 43 is different from the base plate 12.

In the next step, as shown in FIG. 4(b), a semiconductor thin film 42 is formed on the sacrifice layer 41 using a material such as AlGaAs through an epitaxial growth with a vapor growth method such as an MOCVD method.

In the next step, as shown in FIG. 4(c), the p-type semiconductor portions 33 are formed in the semiconductor thin film 42, thereby forming the p-n connection functioning as the LEDs. Note that the semiconductor thin film 42 has a layer structure formed of the semiconductor layer 31 and the n-type semiconductor layer 32 shown in FIG. 3.

In the next step, a photolithography etching is performed using an etchant such as phosphoric acid and the likes to form a rectangular area having a specific width and a specific length including a specific number of the p-type semiconductor portions 33.

In the next step, the semiconductor thin film 42 and the base member 43 are immersed in a removal etchant such as hydrofluoric acid, hydrochloric acid, and the likes. Accordingly, the sacrifice layer 41 is removed, and the semiconductor thin film 42 having the p-type semiconductor portions 33 (or a single p-type semiconductor portion 33) is separated from the base member 43 as shown in FIG. 4(d).

In the next step, as shown in FIG. 4(e), after the semiconductor thin film 42 is separated from the base member 43, the semiconductor thin film 42 or the thin film LED 15 is pressed against the flattened film 16 formed on the base plate 12, so that the thin film LED 15 is attached to the base plate 12. Note that the flattened film 16 is not shown in FIG. 4(d).

In the embodiment, it is preferred that the flattened film 16 is formed of an insulation thin film of an organic material. Accordingly, the flattened film 16 adheres to the semiconductor thin film 42 or the thin film LED 15 through an intermolecular force such as hydrogen bonding.

In the next step, as shown in FIG. 4(f), the thin film LED 15 is etched to form the separation grooves reaching the semiconductor layer 31 or the element separation portions 34, so that the thin film LED 15 has an array structure. Note that, after the step, an insulation material may be filled in the separation grooves for flattening.

Afterward, the p-side electrodes 35 and the n-side electrodes 36 are formed through a vapor deposition-photolithography-etching method, a lift method, and the likes. Through the steps described above, it is possible to obtain a single or the array structure of the thin film LED 15 adhered to the base plate 12.

When a single thin film LED 15 is produced, the step shown in FIG. 4(f) may be performed before the step shown in FIG. 4(d) and after the step shown in FIG. 4(c).

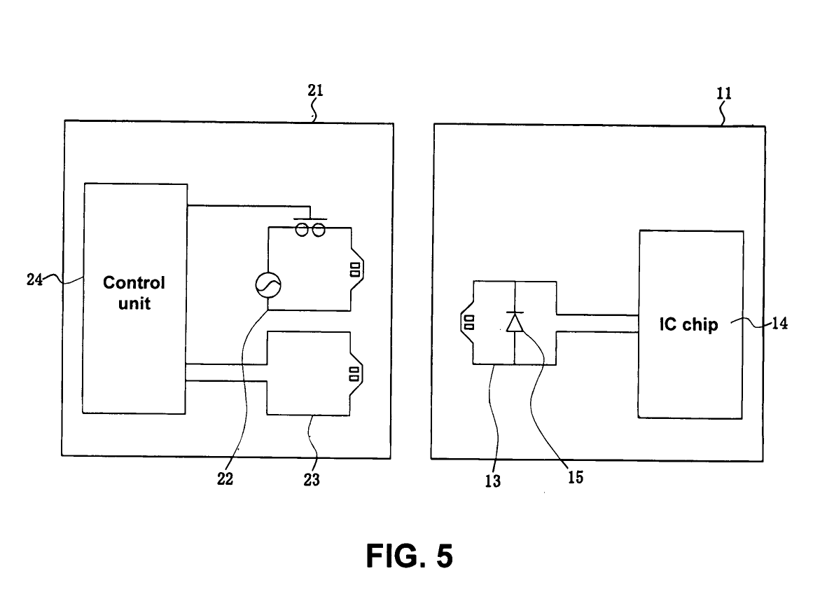

An operation of the RFID label 11 will be explained next. FIG. 5 is a schematic view showing a system of the RFID label 11 and the RFID reader-writer device 21 according to the first embodiment of the present invention.

As shown in FIG. 5, the RFID reader-writer device 21 includes a control unit 24; a writing antenna 22 for receiving a writing signal and power from the control unit 24; and a reading antenna 23 for receiving a reading signal from the RFID label 11. When information is read or written, the RFID label 11 is placed closer to the RFID reader-writer device 21. Accordingly, the antenna 13 of the RFID label 11 receives the reading signal and power from the writing antenna 22 through an electro magnetic effect.

When the antenna 13 receives power, the thin film LED 15 connected to the antenna 13 emits light. When the IC chip 14 receives the writing signal from the control unit 24 through the antenna 13, the IC chip 14 performs a processing corresponding to the writing signal, and sends a response signal to the antenna 13. As a result, through the electro magnetic effect on the antenna 13, the response signal is generated in the reading antenna 23. Accordingly, the control unit 24 performs a specific processing upon receiving the response signal from the reading antenna 23.

In the embodiment, an adhesive layer is formed on a backside surface of the base plate 12 of the RFID label 11, so that the base plate 12 can be attached to various articles. When an article with the RFID label 11 attached thereto is placed close to the RFID reader-writer device 21, the RFID reader-writer device 21 reads information stored in the IC chip 14 from the RFID label 11, thereby performing a processing immediately.

In the embodiment, as described above, the thin film LED 15 is mounted on the base plate 12 as the light emitting member. Accordingly, when the RFID reader-writer device 21 supplies power to the RFID label 11, the thin film LED 15 emits light. As a result, it is possible to recognize that the RFID reader-writer device 21 reads information in the RFID label 11, or write information to the RFID label 11.

In the embodiment, the thin film LED 15 has a thickness of about 2.0 μm. Accordingly, when the base plate 12 is deformed, the thin film LED 15 is not damaged through crystal destruction, thereby maintaining constant emission property.

In the embodiment, the RFID label 11 is explained as the flexible display member, and the flexible display member is applicable to any label or display member having the light emitting member.

As described above, in the embodiment, the thin film LED 15 is attached to the base plate 12 through an intermolecular force. Accordingly, when the base plate 12 is deformed, it is difficult to damage the thin film LED 15, thereby providing the RFID label 11 as the flexible display member with high reliability.

### Second Embodiment

A second embodiment of the invention will be described next. Components in the second embodiment similar to those in the first embodiment are designated by the same reference numerals, and explanations thereof are omitted. Further, explanations of operations and effects in the second embodiment similar to those in the first embodiment are omitted.

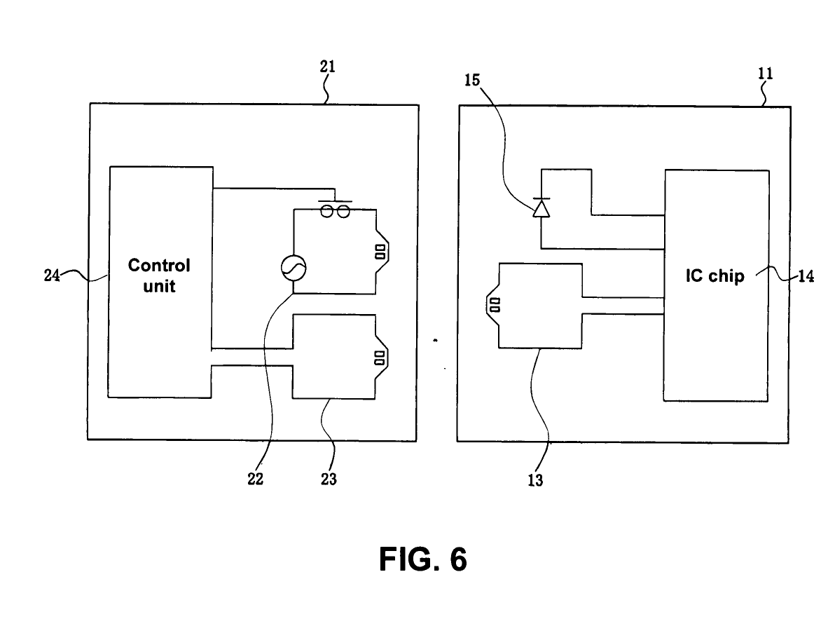

FIG. 6 is a schematic view showing a system of the RFID label 11 and the RFID reader-writer device 21 according to the second embodiment of the present invention.

In the second embodiment, similar to the first embodiment, the RFID label 11 includes the antenna 13, the IC chip 14, and the thin film LED 15. Different from the first embodiment, the thin film LED 15 is connected to the IC chip 14, so that the IC chip 14 drives the thin film LED 15 to emit light. Other configurations of the RFID label 11, a method of producing the RFID label 11, and a method of attaching the RFID label 11 are similar to those in the first embodiment, and explanations thereof are omitted. A configuration and an operation of the RFID reader-writer device 21 are similar to those in the first embodiment, and explanations thereof are omitted.

An operation of the RFID label 11 will be explained next. When information is read or written, the RFID label 11 is placed closer to the RFID reader-writer device 21. The antenna 13 of the RFID label 11 receives a reading signal and power from the writing antenna 22 of the RFID reader-writer device 21 through an electro magnetic effect.

When the IC chip 14 receives a signal from the control unit 24 of the RFID reader-writer device 21 through the antenna 13, the IC chip 14 performs a processing corresponding to the signal, and sends a response signal to the antenna 13. At the same time, the IC chip 14 drives the thin film LED 15 to emit light, thereby indicating that the IC chip 14 performs the processing corresponding to the signal.

Through the electro magnetic effect on the antenna 13, the response signal is generated in the reading antenna 23 of the RFID reader-writer device 21. Accordingly, the control unit 24 performs a specific processing upon receiving the response signal from the reading antenna 23.

As described above, in the embodiment, after the IC chip 14 of the RFID label 11 performs the processing corresponding to the signal sent from the RFID reader-writer device 21, the IC chip 14 drives the thin film LED 15 to emit light. Accordingly, it is possible to indicate that the IC chip 14 performs the processing corresponding to the signal sent from the RFID reader-writer device 21. The processing may include a processing stored in the memory for updating or reading information.

As described above, in the embodiment, the thin film LED 15 is connected to the IC chip 14, so that the IC chip 14 drives the thin film LED 15 to emit light. After the IC chip 14 of the RFID label 11 performs the processing corresponding to the signal sent from the RFID reader-writer device 21, the IC chip 14 drives the thin film LED 15 to emit light. Accordingly, it is possible to indicate that the RFID label 11 actually performs the processing corresponding to the signal sent from the RFID reader-writer device 21.

In the first and second embodiments, the RFID label 11 is explained as the flexible display member, and the flexible display member is applicable to an IC card having a light emitting member on a flexible base member, a display element or a display device having a curvature, and the likes.

The disclosure of Japanese Patent Application No. 2007-059338, filed on Mar. 9, 2007 is incorporated in the application by reference.

While the invention has been explained with reference to the specific embodiments of the invention, the explanation is illustrative and the invention is limited only by the appended claims.

What is claimed is:

1. A flexible display member comprising:
a base member having flexibility; and
a thin film LED (Light Emitting Diode) mounted on the base member.

2. A flexible display member comprising:
a base member having flexibility;
an antenna mounted on the base member; and
a thin film LED (Light Emitting Diode) mounted on the base member said thin film LED receiving power from the antenna.

3. The flexible display member according to claim 1, wherein said thin film LED is attached to the base member through an intermolecular force.

4. The flexible display member according to claim 2, wherein said thin film LED is attached to the base member through an intermolecular force.

5. The flexible display member according to claim 1, further comprising an adhesive layer formed on a backside surface of the base member.

6. The flexible display member according to claim 2, further comprising an adhesive layer formed on a backside surface of the base member.

7. An article having the flexible display member according to claim 1 attached thereto.

8. An article having the flexible display member according to claim 2 attached thereto.
